(19) United States
(12) Patent Application Publication
(10) Pub. No.: US 2022/0006697 A1
(43) Pub. Date: Jan. 6, 2022

(54) PATH COMPUTATION TOOL FOR A COMMUNICATIONS NETWORK

(71) Applicant: Level 3 Communications, LLC, Broomfield, CO (US)

(72) Inventors: George HILL, Monroe, LA (US); Bryan HORNE, Gardner, KS (US); Jason CLEARY, Rochester, NY (US); Jason PARRIS, Gardner, KS (US); Andrew GLOVER, Layton, UT (US)

(21) Appl. No.: 17/365,864

(22) Filed: Jul. 1, 2021

Related U.S. Application Data
(60) Provisional application No. 63/047,803, filed on Jul. 2, 2020.
(60) Provisional application No. 63/153,424, filed on Feb. 25, 2021.

(51) Int. Cl. H04L 12/24; H04L 12/733; H04L 12/717

(52) U.S. Cl. CPC H04L 41/0816; H04L 41/0853; H04L 45/42; H04L 41/22; H04L 45/126; H04L 41/0883

(57) ABSTRACT

A tool is provided to generate one or more communication paths through one or more networks from a starting location to an ending location. The generated communication paths may be displayed for comparison by a user or computing device and, upon selection, the one or more networks may be configured or provisioned to instantiate a selected communication path in the networks. In particular, the selected communication path may be provided to one or more corresponding network configuration systems to communicate with the network devices in the communication path and alter the operating state of the network devices according to the communication path information. Some implementations of the network path tool may provide an auditing of diversity aspects of a network path or circuit that may receive network path information and display diversity audit information through any user interface utilized by the path computation tool.

### Cross-Reference to Related Application

This application is related to and claims priority under 35 U.S.C. § 119(e) from U.S. Patent Application No. 63/047,803, filed Jul. 2, 2020 entitled “PATH COMPUTATION TOOL FOR A COMMUNICATIONS NETWORK” and from U.S. Patent Application No. 63/153,424, filed Feb. 25, 2021 entitled “PATH COMPUTATION TOOL FOR A COMMUNICATIONS NETWORK”, the entire contents of both of which are incorporated herein by reference for all purposes.

### TECHNICAL FIELD

Embodiments of the present invention generally relate to systems and methods for implementing a telecommunications network, and more specifically for a system to generate a proposed communication or transmission path through communication networks based on information received from network information sources such as databases.

### BACKGROUND

A telecommunication network provides various possible computing devices with various possible services including communication paths between devices, network services, access to content, access to computing and storage environments, access to various cloud services, etc. To provide such services, one or more communication paths over the communications network are provisioned. Any given path may include various intermediate devices between the endpoints, and in many instances may require components from different communication networks to reach an end-point for any given service. Generally, a network engineer is responsible for establishing a path for a customer. That is, a network engineer may receive a request from a customer for some service, and the engineer must then do several things to fulfill the request including determining the endpoints, determining which components of the network are to be configured or provisioned to provide the requested service between the endpoints, and then configuring the communication path between the various devices. Such a process is challenging for a host of reasons—records may be incomplete, unique devices may require special knowledge to configure, among many other challenges. Thus, in conventional environments, determining and configuring a path for a customer to access a network service is time consuming and requires deep and specialized knowledge of the available network components and services provided by the network.

It is with these observations in mind, among other, that aspects of the present disclosure were conceived.

### SUMMARY

One aspect of the present disclosure relates to a method for managing a communications network. The method may include the operations of receiving an identification of a first geographic location and an identification of a second geographic location, both associated with a network and generating, based on a path parameter and obtained network information, a communication path from a first network device located at the first geographic location to a second network device located at the second geographic location, the communication path comprising a third network device connected logically between the first network device and the second network device and a network circuit connecting the first network device to the third network device. The method may also include the operation of generating a display of a visual representation of the communication path, the visual representation comprising an identification of the first network device, an identification of the third network device, and an identification of the network circuit.

Another aspect of the present disclosure relates to a system for managing a communications network. The system may include one or more processors and a non-transitory storage device including computer executable instructions. Execution of the computer executable instructions causes the one or more processors to obtain, based on an identification of a first network path of a communication network, an identification of a second network path associated with the first network path, determine a diversity of components of the first network path to associated components of the second network path, and generate a displayable result of a comparison of the determined diversity of the components of the first network path to associated components of the second network path, the comparison based on a diversity parameter of a request associated with the first network path.

### BRIEF DESCRIPTION OF THE DRAWINCIS

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

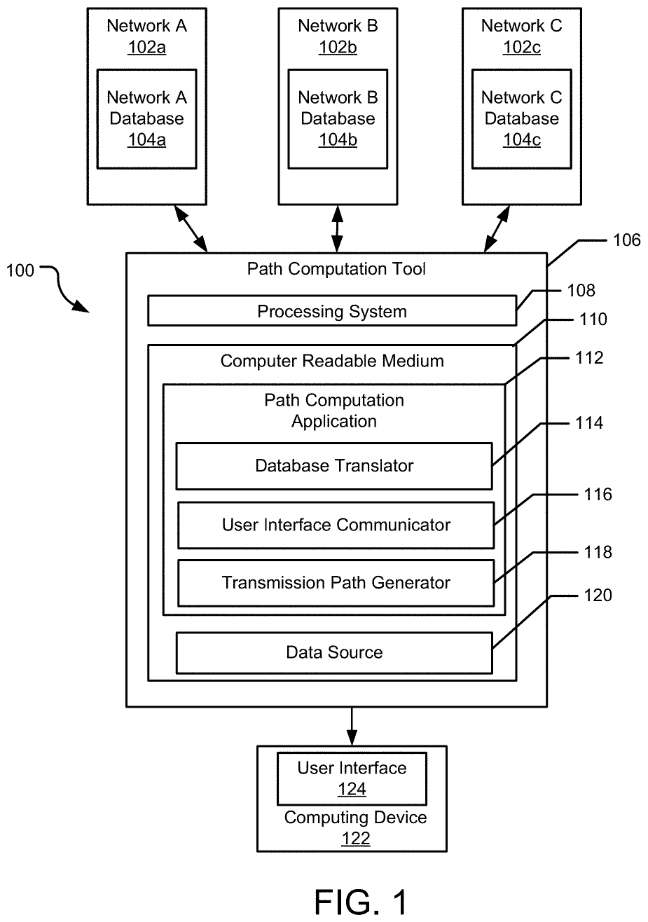

FIG. 1 is a schematic diagram illustrating a system for path determination through a communications network in accordance with one embodiment.

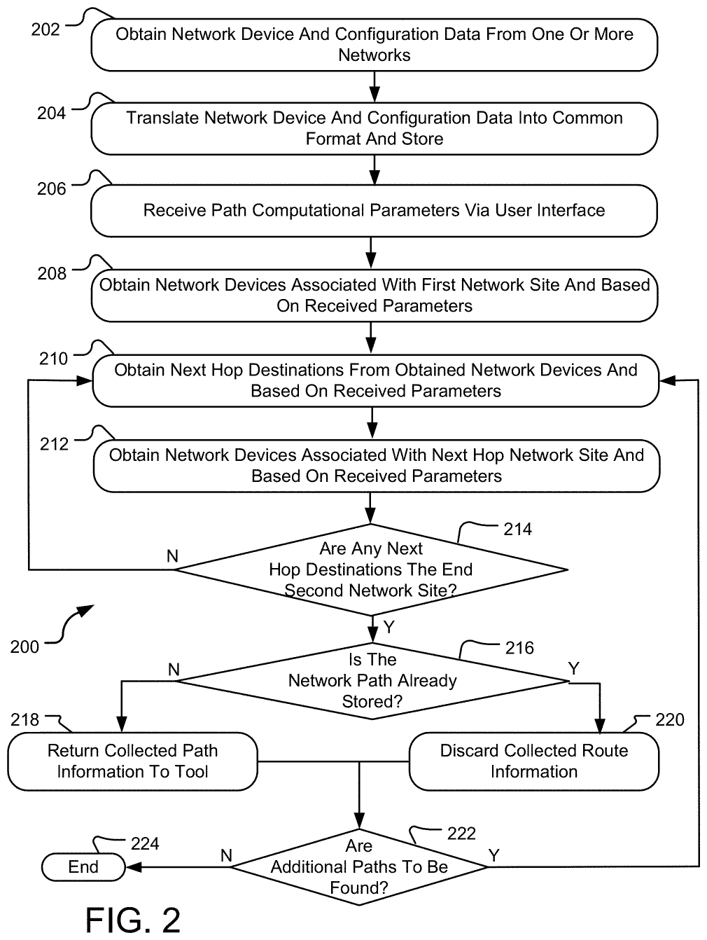

FIG. 2 is a flowchart illustrating a method for determining a network path through a communications network in accordance with one embodiment.

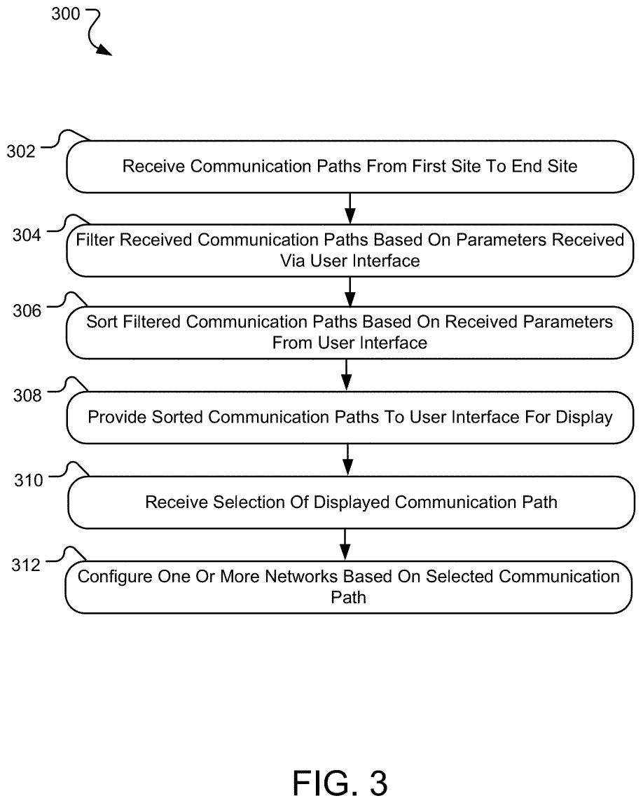

FIG. 3 is a flowchart illustrating a method for displaying a network path through a communications network in accordance with one embodiment.

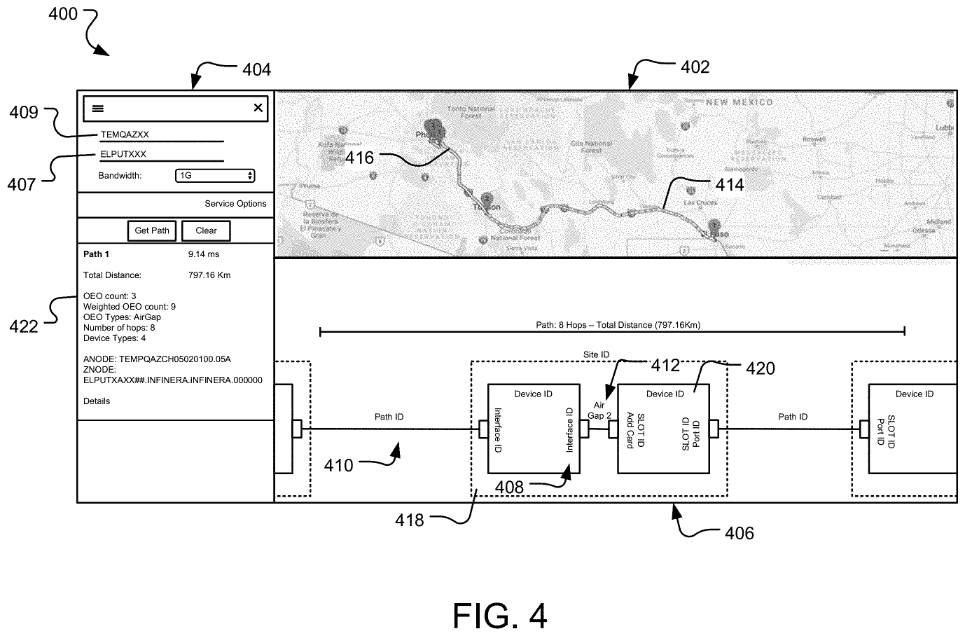

FIG. 4 is an example user interface for displaying a network path through a communications network based on one or more path parameters in accordance with one embodiment.

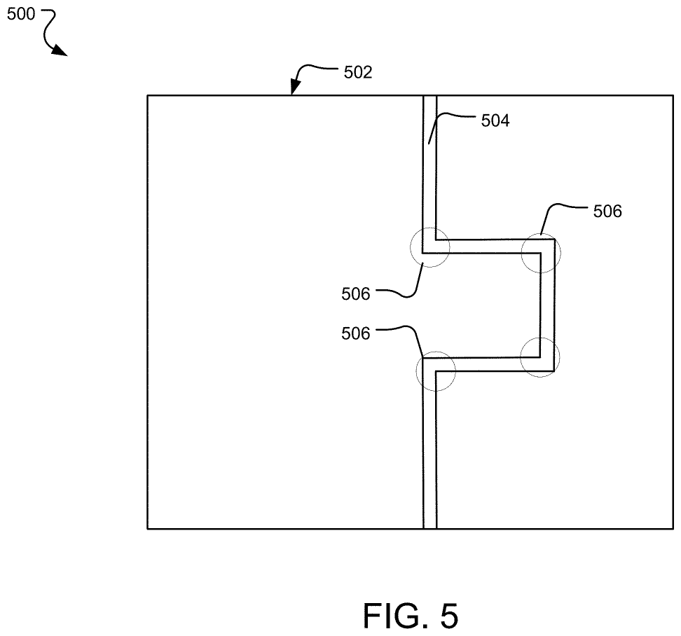

FIG. 5 is an example user interface illustrating portions of a network path through a communications network in accordance with one embodiment.

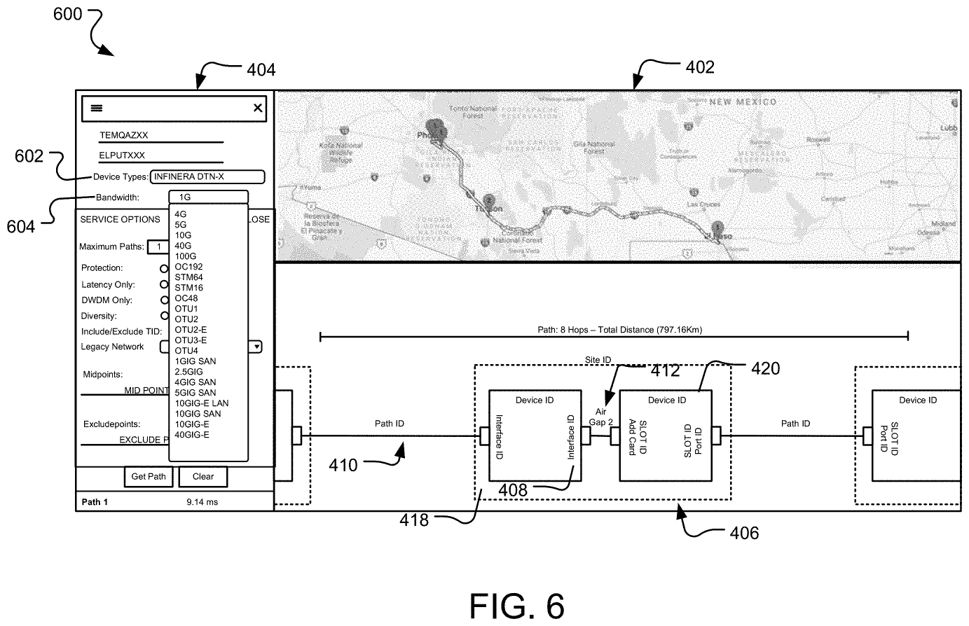

FIG. 6 is an example user interface for inputting a bandwidth selection via the user interface for determining a network path of a communications network in accordance with one embodiment.

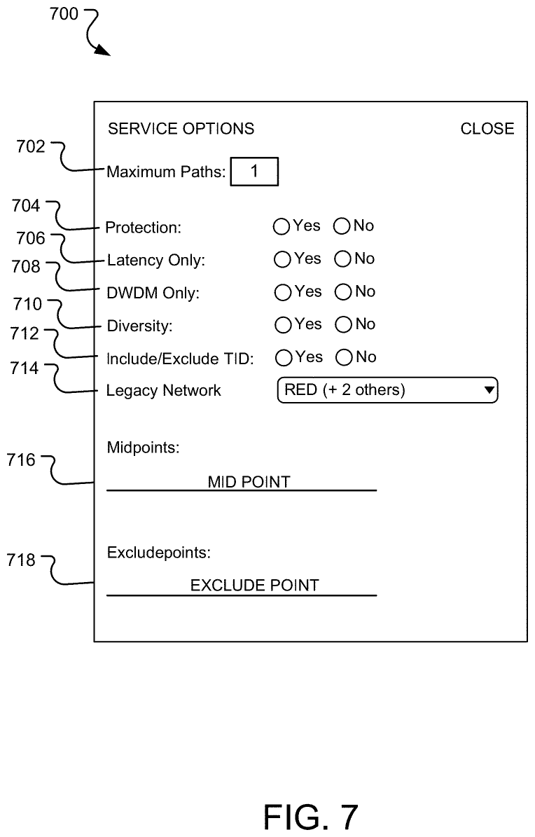

FIG. 7 is an example user interface for receiving one or more network path parameters for determining a network path of a communications network in accordance with one embodiment.

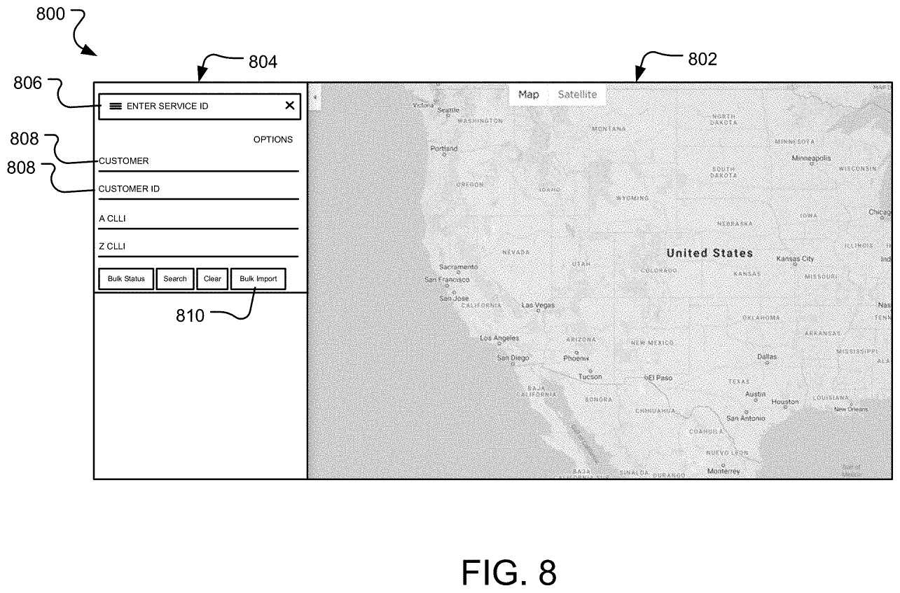

FIG. 8 is an example user interface for receiving one or more network path parameters for auditing a diversity aspect of a network path of a communications network in accordance with one embodiment.

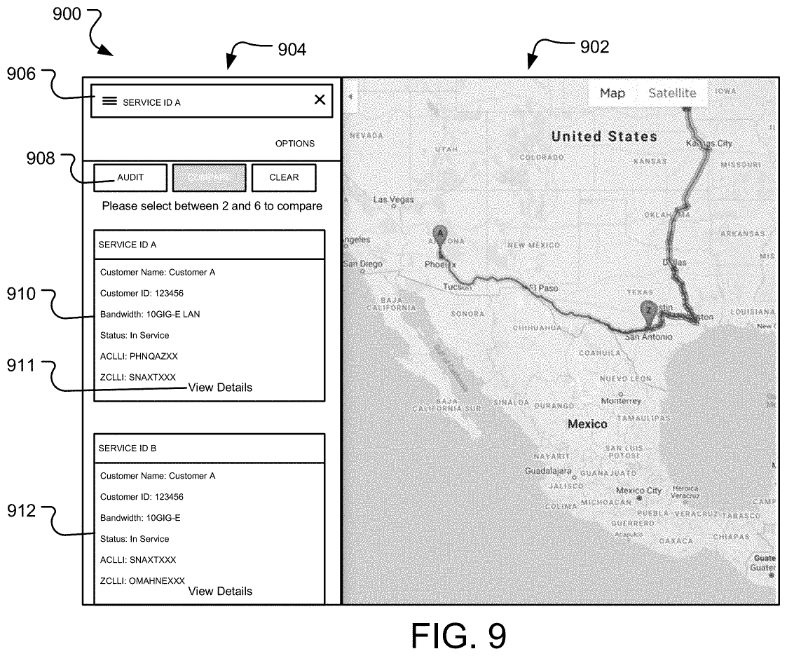

FIG. 9 is an example user interface for displaying one or more network paths and associated parameters for auditing a diversity aspect of the network paths in accordance with one embodiment.

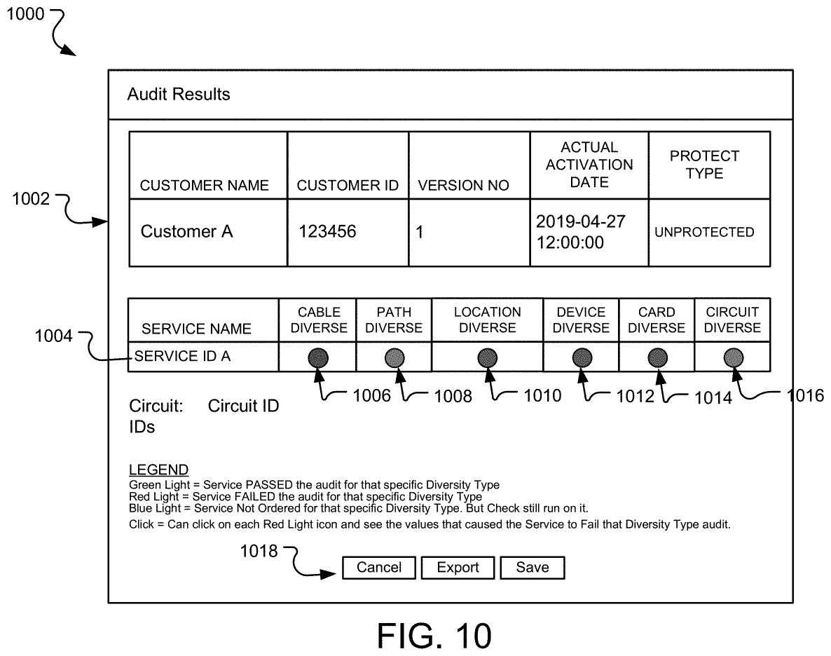

FIG. 10 is an example screenshot of a user interface displaying diversity audit results for a network path in accordance with one embodiment.

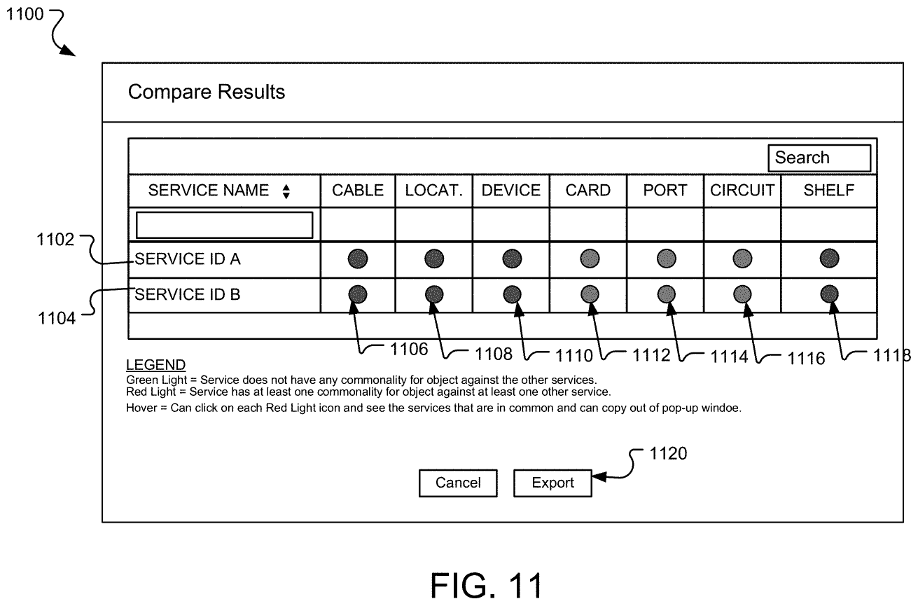

FIG. 11 is an example screenshot of a user interface displaying diversity comparison results for two or more network paths in accordance with one embodiment.

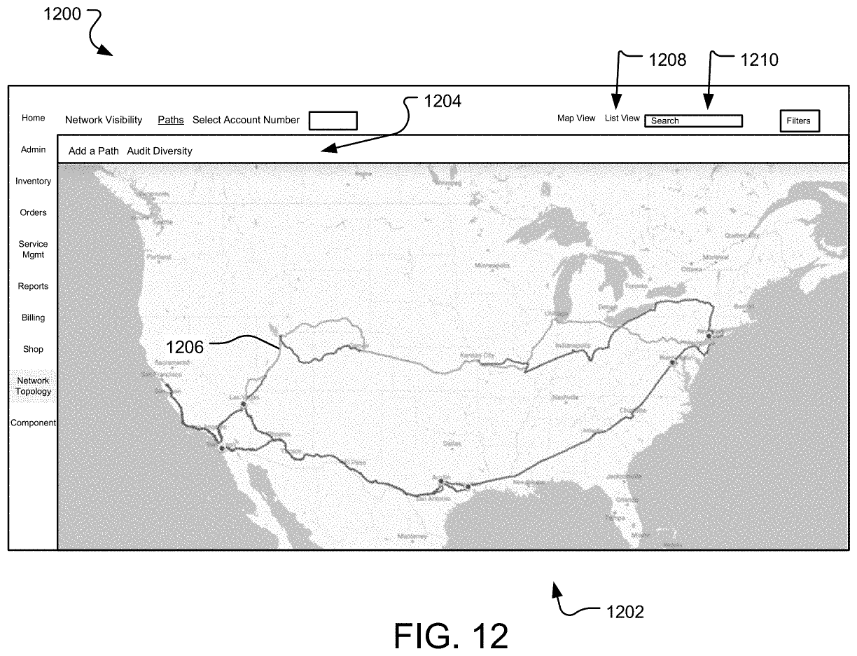

FIG. 12 is a second example user interface for displaying a network path through a communications network based on one or more path parameters in accordance with one embodiment.

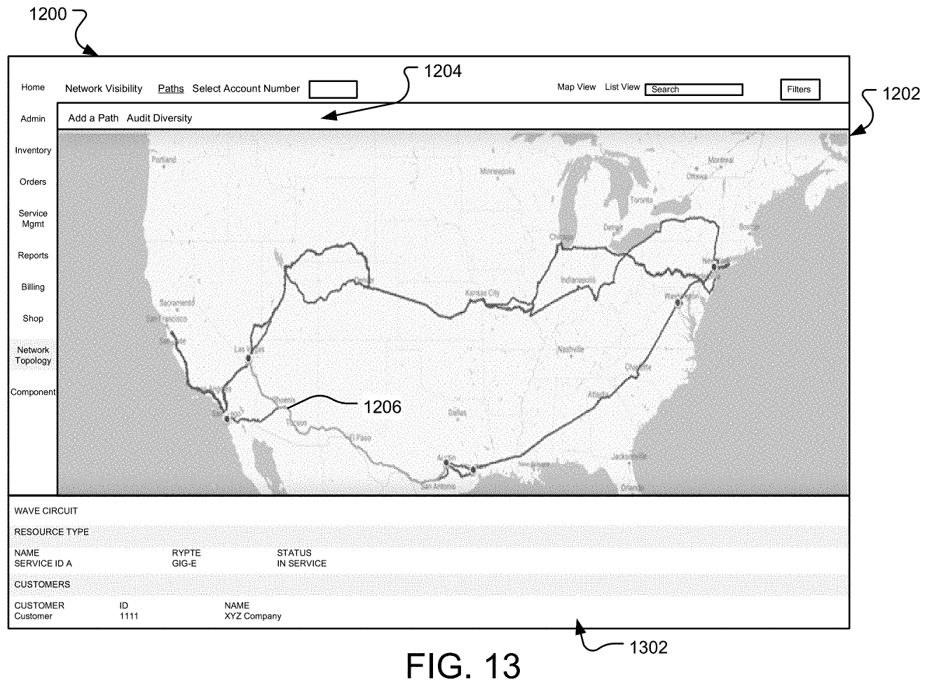

FIG. 13 is an example screenshot of a user interface displaying network path information in accordance with one embodiment.

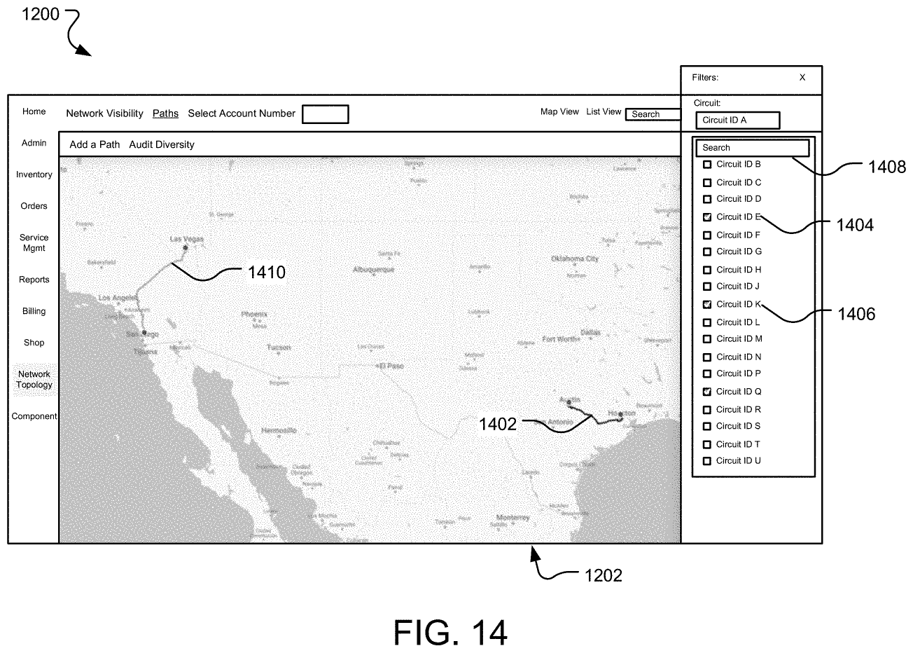

FIG. 14 is an example screenshot of a filter function of a user interface for selecting network paths for display in the user interface in accordance with one embodiment.

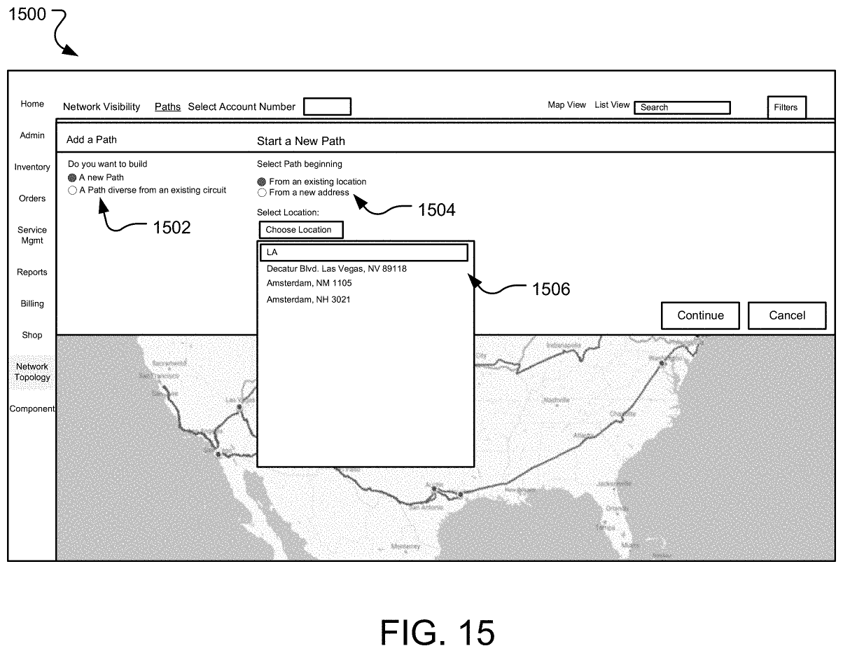

FIG. 15 is an example screenshot of a user interface for generating a new network path for a communication network in accordance with one embodiment.

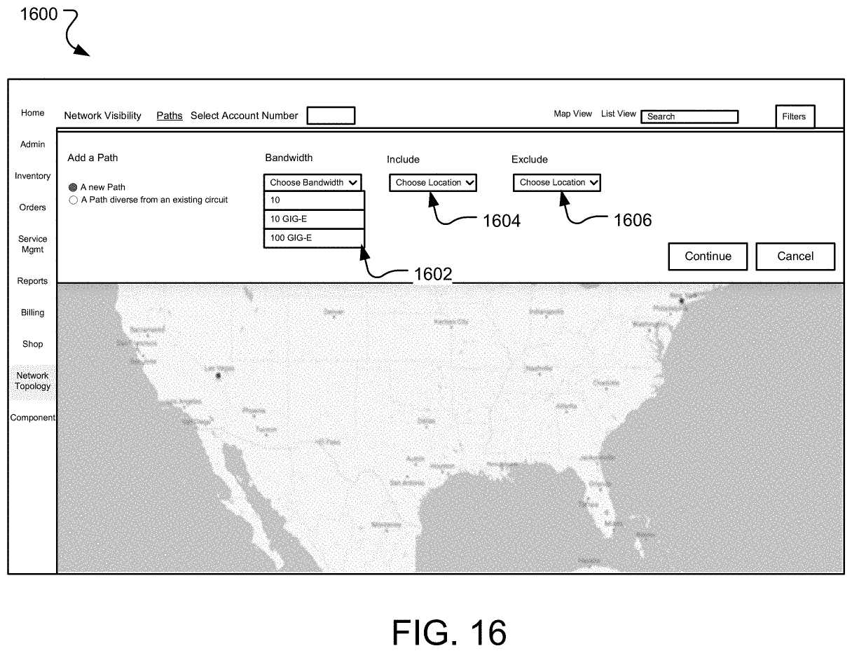

FIG. 16 is an example screenshot of a user interface for receiving one or more network path parameters for a new network path of a communications network in accordance with one embodiment.

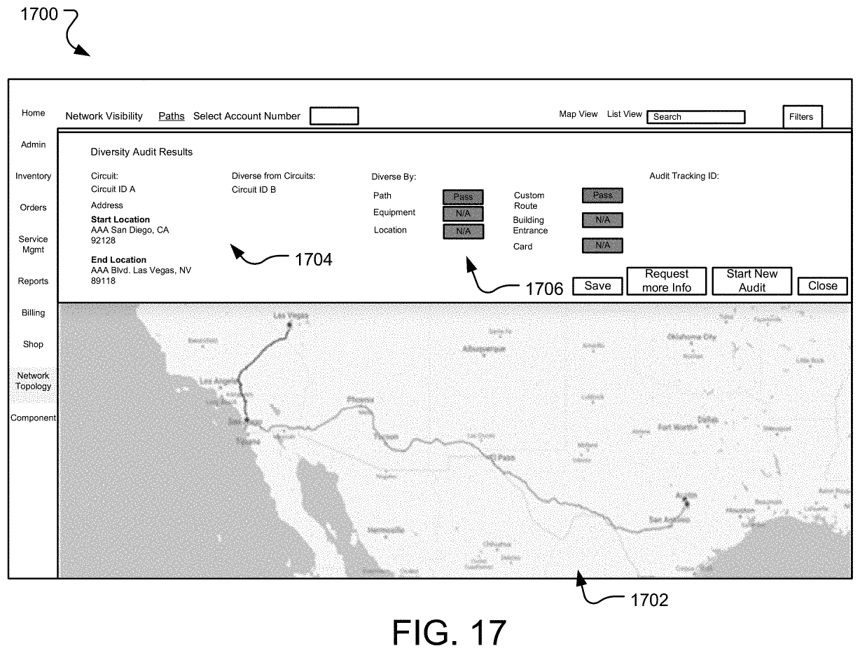

FIG. 17 is an example screenshot of a second user interface displaying diversity audit results for a network path in accordance with one embodiment.

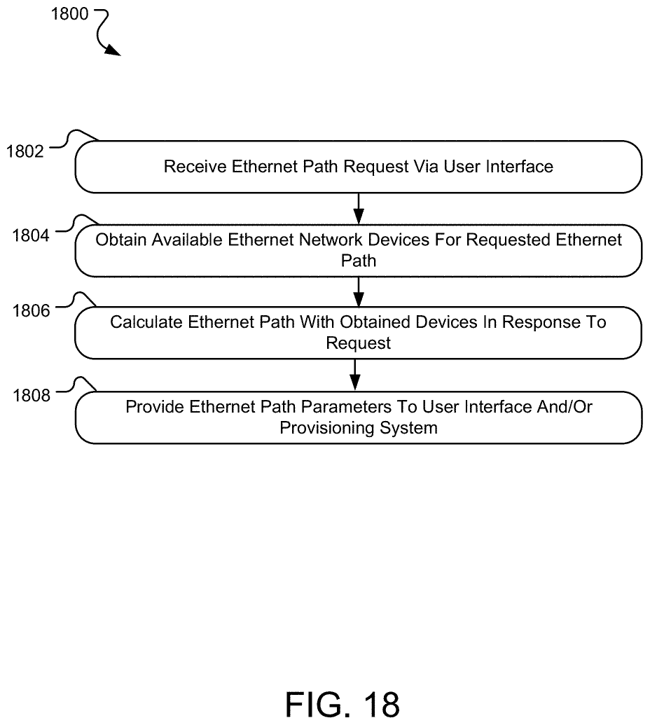

FIG. 18 is a flowchart illustrating a method for determining an Ethernet network path through a communications network in accordance with one embodiment.

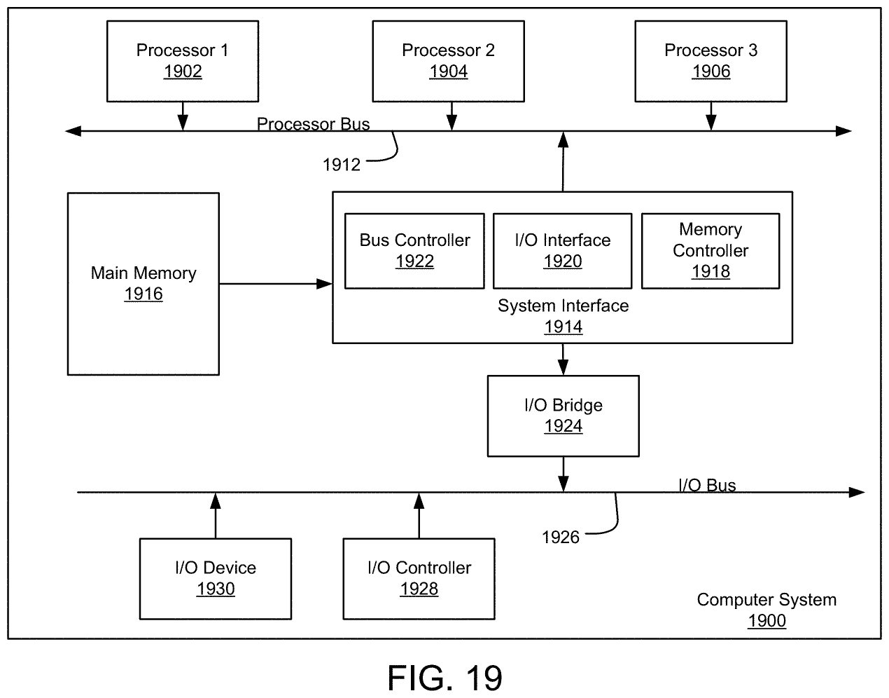

FIG. 19 is a diagram illustrating an example of a computing system which may be used in implementing embodiments of the present disclosure.

### DETAILED DESCRIPTION

Through the systems and methods described herein, a computing tool for computing or otherwise determining a communication path through a communications network is provided. The tool may receive an identification of a starting location and an ending location for the communication path and, based on network information, determine a communication path through a communication network (or networks) for transmitting information between the starting location and the ending location. In particular, the tool may access a source or sources of information pertaining to aspects of defining a path through the network or networks. The source(s) of information may include one or more databases to obtain network information, such as but not limited to, network component identifiers, network connection information, port assignment information, network component locations, and the like. The tool may utilize the network information to generate a path for communications to transit between the starting (first) location and the ending (second) location to provide a service or services to a customer device or devices. It should be recognized that the path may be, and typically will be, bi-directional in that the services will involve information communicated between the first and second location. The path definition may include any type of network information, such as transmission lines, network components, port assignments, etc. In some instances, the path definition may provide suggested connections between components, which connections may not already exist within the network. In many network arrangements, there may be more than one possible path between points and multiple paths are often advised for redundancy, to avoid or minimize single points of failure, to circumvent congestion and for other reasons. Thus, in some instances, the tool may determine alternative or different connection paths between the locations. The alternative connection paths may be wholly distinct or may overlap with other paths. In this manner and through the connection tool, one or more connection paths may be determined and instantiated within the network to provide services.

In one implementation, a computer generated and displayed user interface may be associated with the connection path tool to provide determined path results and/or receive constraints or parameters for the generation of the connection path. For example, a user may input, via the user interface, connection path parameters, such as but not limited to network device types, requested connection path bandwidth, number and type of network databases for referencing in identifying path information, midpoint locations, and the like. In general, the user interface and tool may be configured to allow specification of any number of parameters for generating or altering a connection path.

In addition, the tool may display the determined connection paths, such as via the user interface. In one instance, the user interface may generate an interactive map including the determined connection path through which aspects of the connection path may be displayed when selected via an input device to the user interface. For example, the interactive map may provide for selection of portions of the connection path and information related to or associated with the selected portion may be displayed. Such displayed information may include port assignments, network devices, access points to physical structures (such as buildings, homes, etc.), down to street-level relays used in the connection path. Providing network information at such a network component or port assignment granularity provides a network engineer with all potentially relevant information for provisioning the connection path within the network. Further, a customer to the network may utilize the tool to select, alter, define, and the like a desired connection path within the network. Upon generation, the connection path information may be provided to the network or a network engineer for provisioning on the network. For example, a customer or engineer of a network may utilize the path computation tool to generate different communication paths through the network and compare one or more performance metrics of the generated paths, such as geographic footprint, sites and components of the network through which the path traverses, transmission speeds, redundancy availability, and the like. Based on the path comparison, a particular communication path may be selected for inclusion in the network and data or information associated with the selected path, such as ports used, components utilized, identified transmission lines between sites, and the like may be provided to a network engineer or provisioning system to provision one or more components or other aspects of the network to instantiate the selected path through the network. In this manner, the path computation tool may provide a user with a simple and easy way to generate a proposed communication path through the network and provision the network to include a selected path.

In addition, the user interface may include a visual representation of the network components and connection information between the network components of the connection path. Other obtained or determined information of the connection path may also be displayed. Further, the display of the connection paths of the network may be controlled or altered via the user interface. For example, a display parameter may indicate display of the determined connection path with the lowest total latency of the multiple determined paths. In another example, the determined connection path with the shortest geographic distance or shortest logical distance within the network may be selected for display in the user interface. In general, any number of display parameters may be provided via the user interface to determine the connection path displayed in the user interface. The display parameters may be selected by a user of the tool to generate one or more communication paths based on an aspect of the network that is of interest to the user.

As explained above, the tool may obtain network configuration information, including but not limited to, network component identifiers, network connection information, port assignment information, component locations, and the like, from multiple network databases. In some instances, the network databases may be associated with separate communication networks. For example, the tool may access and obtain information stored in separate network databases for networks that are being integrated into a single communications networks package to provide services from both networks to customers. Further, the network databases may store network information of the respective networks in different formats. Thus, the tool may translate the network information obtained from the separate databases into a common format for use by the tool. The translated information may be stored by the tool in a common database for ease of access by the tool. As such, the tool may periodically, aperiodically, as needed, etc., access the network databases to obtain newly stored network information, translate the new information, and store the translated information in the shared database for the tool. In this manner, the separate databases of different networks may be accessible by the tool for generating connection paths through the various related networks.

FIG. 1 is a schematic diagram illustrating a system 100 for path determination in accordance with one embodiment. In general, the system 100 may include a path computation tool 106 in communication with a source of information such as one or more network databases 104a-c associated with one or more respective networks 102a-c. The path computation tool 106 may also be in communication with a computing device 122 providing a user interface 124. The interactions and communications between the components of the path computation system 100 is described in more detail herein.

As explained above, the path computation tool 106 may determine one or more communication paths through one or more communications networks between two locations, referred to herein as a starting (or first) location or site and an ending (or second) location or site. Although referred to as a starting location and an ending location, the locations between which the communication paths are determined may be bi-directional such that communications may traverse the determined paths in either direction. In some instances, the path computation tool 106 may include a path computation application 112 executed to perform one or more of the operations described herein. The path computation application 112 may include computer executable instructions stored in a non-transitory computer readable media 110 (e.g., memory) and executed on a processing system 108 of the path computation tool 106 or other type of computing system, such as that described below. For example, the path computation application 112 may include instructions that may be executed in an operating system environment, such as a Microsoft Windows™ operating system, a Linux operating system, or a UNIX operating system environment. The computer readable medium 110 includes volatile media, nonvolatile media, removable media, non-removable media, and/or another available medium. By way of example and not limitation, non-transitory computer readable medium 110 comprises computer storage media, such as non-transient storage memory, volatile media, nonvolatile media, removable media, and/or non-removable media implemented in a method or technology for storage of information, such as computer readable instructions, data structures, program modules, or other data.

The path computation application 112 may also utilize a data source 120 of the computer readable media 110 for storage of data and information associated with the path computation tool 106. For example, the path computation application 112 may store information associated with one or more networks 102a-c over which a path may be defined. In general, any data or information utilized by the path computation application 112 may be stored and/or retrieved via the data source 120.

The path computation application 112 may include several components to perform one or more of the operations described herein. For example, a database translator 114 may be included in the path computation application 112 to translate network information obtained from the databases 104 associated with one or more communication networks 102. In the example shown in FIG. 1, the path computation tool 106 may communicate with a database 104a associated with a network A 102a, a database 104b associated with a network B 102b, and a database 104c associated with a network C 102c. The path computation tool 106 may communicate with more or fewer such databases 104 in more or fewer networks 102. In general, each of the networks 102 comprise a collection of interconnected network components to transmit messages or packets within the networks. However, network operators may purchase existing networks and integrate those networks into a main network to expand the geographical footprint of the main network. These purchased or obtained networks may include databases 104 with network component information, such as component locations, interconnectivity information, component types, port assignments of the components, and the like. More generally, it may simply be the case that different databases are used, such as in situations with legacy or older portions of the network, with different formats in which network information is stored. Hence, each network 102 may maintain the network component information in a particular format in the associated database 104 or databases for that network. Such disparate storage may also be applicable to different parts of a network and not necessarily distinct networks being merged or otherwise interconnected and integrated. Such formats may vary from network to network such that information may be stored in a first database, such as database 104a, in a first format while information stored in a second database, such as database 104b, in a second format different than the first format.

As the network information in the various network databases 104 in communication with the path computation tool 106 may be stored in various formats, the database translator 114 of the path computation application 112 may translate the network information from the databases 104 into a common format and store the translated information in data source 120. In some instances, the database translator 114 may translate the network information prior to storage in the data source 120. In another implementation, the network information may be stored in the data source 120 as obtained from the respective database 104 and translated when accessed by the application 112 during path computation. In still another instance, the database translator 114 may be an Application Programming Interface (API) configured to facilitate communications between the path computation tool 106 and one or more databases, including translating instructions from one communication protocol to another. Regardless, the database translator 114 may be configured to identify a format of stored network information and translate the obtained stored information to the common format.

The path computation application 112 may also include a user interface communicator 116 to communicate with a computing device 122 executing a user interface program 124. The computing device 122 may provide the user interface 124 (e.g., a command line interface (CLI), a graphical user interface (GUI), etc.) displayed on a display, such as a computer monitor or other display device, for displaying data. Through the user interface 124, a user may provide control inputs for manipulating the path computation application 112 through one or more input devices. The inputs may be used by the path computation application 112 to, among other things, control the components and locations included in the network communication path, filter results of path computation for display of the communication path on the display, and the like. The input device for providing the inputs may include, among others, a keyboard or a pointing device (e.g., a mouse, trackball, pen, or touch screen) to enter data into or interact with the user interface 124.

In one example, the user interface 124 may communicate with other components in the path computation application 112 to receive user input for manipulating or otherwise modifying the operation of the path computation application. For example, user interface communicator 116 may communicate with user interface 124 of the computing device 122 to receive path computation parameters for use by the transmission path generator 118 discussed below. The user interface communicator 116 may also provide information to for display via the user interface 124, such as determined or calculated communication paths through one or more networks as generated by the path computation tool 106. As another example, the user interface 124 may receive user input for selecting one or more generated communication paths for display in the user interface. The parameters for communication path display may be provided to the transmission path generator 118 for selecting a generated communication path for transmission to the computing device 122 for display.

The path computation tool 106 may also include a transmission path generator 118 for determining or calculating a communications path through one or more communication networks based on one or more received parameters. For example, the transmission path generator 118 may determine a communication path through multiple networks from a received starting location or network site to an ending location or network site. The identification of the starting location and/or the ending location may be provided to the transmission path generator 118 via the user interface 124. The operations of the transmission path generator 118 are described in more detail below with reference to the method 200 of FIG. 2.

It should be appreciated that the components described herein are provided only as examples, and that the application 112 may have different components, additional components, or fewer components than those described herein. For example, one or more components as described in FIG. 1 may be combined into a single component. As another example, certain components described herein may be encoded on, and executed on other computing systems, such as on one remotely coupled to path computation tool 106.

FIG. 2 is a flowchart illustrating a method 200 for determining a network communication path through one or more networks in accordance with one embodiment. In one implementation, one or more of the operations of the method 200 may be performed by the path computation application 112 and, in particular, by the transmission path generator 118 of the application. In other implementations, one or more of the operations may be performed by other components of the path computation tool 106 or still other systems. The operations may be executed by hardware components of the relevant systems, software programs of the systems, or a combination of hardware and software components of the system.

Beginning in operation 202, the path computation application 112 may obtain network component and configuration data or information from one or more databases associated with one or more networks. For example, the database translator 114 (or other component of the path computation tool 106) may access the network databases 104 of one or more networks 102 in communication with the tool. As mentioned above, each database 104 may store network information of a corresponding network 102, such as network component specifications, network component identifications, component locations, transmission line information, port assignments, component and line capacity, and the like. In some instances, a network 102 may include multiple databases 104 storing network information such that the path computation tool 106 may access each database 104 of the network 102 to obtain all network information from the respective network. Accessing the databases 104 may, in some instances, occur periodically or in response to a trigger to obtain updated or new network information as such information is added to the databases 104.

In operation 204, the path computation tool 106 may utilize the database translator 114 to translate the obtained network information from the network databases 104 into a common format for use by the path computation application 112. The format for the network information may be any format supported by the path computation application 112. The path computation tool 106 may also store the translated network information in the data source 120 for use in generating communication path through the network or networks.

In operation 206, the path computation tool 106 may receive, via the user interface 124 executed on the computing device 122, one or more path computation parameters. In one implementation, the computing device 122 may determine and provide, via the user interface or directly to the path computation tool 106, the path generation parameters to obtain specified or limited communication paths through the networks. In another implementation, a user of the computing device 122 may input one or more parameters to tailor the communication path generation. The path generation parameters may define particular bounds of the path generation executed by the transmission path generator 118. For example, the parameters may include an identification of a first or starting location associated with the network from which a communication path is to be generated. The starting location identifier may include a geographic location, an identification of a termination site of the network, a common language location identifier (CLLI) identifier, or the like. In one example, the starting location parameter may include CLLI identifier “TEMQAZXX” associated with a network location in Tempe, Arizona. Similarly, the path generator parameters may include an identification of an ending location associated with the network to which a communication path is to be generated. For example, the ending location may include CLLI identifier “ELPUTXXX” associated with a network location in El Paso, Tex. As should be appreciated, the starting location and ending location may be identified by any location identifier. In some instances, the provided starting and ending locations may be associated with a nearby termination site of the communications network as the closest network access point for the provided locations.

In some instances, obtaining the network device and configuration data from the one or more databases associated with one or more networks (operation 202) and/or translating such data into a common format for storing (operation 204) may occur after the path computation parameters are received via the user interface. In such an embodiment, the data may be requested by path computation tool 106 based on the received path computation parameters.

In another implementation, additional locations identifiers may be provided via the user interface 124 or the computing device 122. For example, one or more geographic location identifiers may be provided as midpoints to be included in the generated communication path. For example, a midpoint of Denver, Colo. may be provided for inclusion between the starting location and the ending location identifiers provided above. Any number of midpoints may be included as a communication path parameter for inclusion in the generated communication path through the network. As such, the system will generate one or more communication paths that include the midpoint provided a path including the midpoint is available. If not, the system will provide a graphic indication that the midpoint requirement cannot be met. In a similar manner, one or more location identifiers may be provided as parameters for exclusion from a generated communication path. Excluded points may avoided by the transmission path generator 118 when generating communication paths through the network.

Still other communication path parameters may be provided by the computing device 122 or the user interface 124. For example, a user may indicate, via the user interface 124, a device type, such as Dense Wavelength Division Multiplexing (DWDM) type networking devices as a parameter for the communication path generation. In general, selection of a device type may limit the types of network components included in the communication path by the path computation tool 106. Thus, in this example, the tool 106 may only include DWDM type network devices in the generated communication path. Other network device types may also be selected, such as optical-only, manufacturer, broadband or wideband devices, and the like. In general, any technical aspect of the network device may be selected as a parameter for the communication path generation. Similarly, a requested bandwidth for components and transmission lines included in generated communication paths may be provided as a path parameter. A requested bandwidth as a parameter for the communication path may limit the network components and transmission lines included in a calculated communication path by the path computation tool. For example, selection of a 40 G bandwidth parameter may cause the path computation tool to only include components and transmission lines with 40 G or more of bandwidth in a computed communication path. Still additional path computation parameters may be provided by the computing device 122 and/or the user interface 124, including but not limited to availability of separate protection communication paths, diversity between generated communication paths, limitations to particular network databases, and the like. These additional communication path parameters are discussed in more detail below with reference to FIG. 6.

In some instances, the path computation tool 106 may include one or more default values for any of the path computation parameters, including default network devices for inclusion, default networks, no excluding network sites, and the like. The path computation tool 106 may also return an error notification to the user interface 124 in some instances in which certain parameters are not input. For example, an error message may be returned to and displayed in the user interface 124 if a starting location or ending location is not provided to the path computation tool 106.

Upon receipt of the path computation parameters or based on default parameter values, the tool 106 may obtain network devices associated with the first or starting location based on the received parameters in operation 208. In particular, the path computation tool 106 may determine a closest network site to the provided starting location of the path parameters. In general, a network site is a location in which one or more network components are housed for connection to other sites of the network. Based on the provided path parameters, the path computation tool 106 may select one or more components of the identified starting site for providing a connection to the requesting customer. The selection of the network components of the starting site that match the parameters may be obtained from the data source 120 or the network databases 104 as an identification of each component (and associated technical or operating information of each component) may be stored in the data source 120 or databases 104. As the path parameters provide constraints on the types and number of network components to be included in a communication path, a subset of all of the network components of the starting site may be selected for potential inclusion in a communication path. In some instances, the nearest network site for the startling location may not include any components that satisfy the path parameters. In such instances, a next closest network site may be identified and a satisfactory network component may be selected for inclusion in the communication path. In this manner, network sites expanding out from the starting location parameter may be analyzed until a qualifying network component is located.

In still other instances, more than one network component of the starting site may be discovered in the starting site through the analysis of the data source 120. In such instances, the path computation tool 106 may retrieve technical and connection information for each qualifying component of the starting site. Based on such information, the computation tool 106 may, in operation 210, obtain next hop destinations for each of the qualifying obtained network devices. The next hop destinations may include network devices connected to the identified network devices of the starting site via a transmission line for exchanging communications with the identified network devices of the starting site. The next hop destinations may include components within the starting site or components in a connecting network site to the starting site. The next hop destinations may also be limited by the path computation parameters. For example, some transmission lines between network sites may not support certain bandwidths. Thus, if a path parameters includes a particular bandwidth, some transmission lines may not be included in the communication path. A similar limitation may be included for device type such that fewer than all devices connected to the network devices of the starting site may be identified as a next hop destination. The path computation tool may also store each of the identified starting site network devices and next hop destination devices for use in generating a communication path through the network. In operation 214 and similar to operation 208, the computation path tool 106 may obtain the network devices associated with next hop network site that match the path computation parameters. In this manner, the devices of the next-hop of the communication path may be obtained and included in a generated communication path.

In operation 214, the path computation tool 106 may determine if any of the next hop destinations are associated with the ending or second network site of the requested communication path. As mentioned above, a path computation parameter may include an ending location to which an ending network site may be associated. Thus, the path computation tool 106 may compare the locations of the next hop destinations to the ending network site to determine if the ending network site has been reached by the tool 106. If the ending network site has not been reached, the path computation tool 106 may return to operation 210 and obtain next hop destinations from the identified components of a potential communication path.

The path computation tool 106 may continue obtaining next-hop destinations connected to sites along the communication path until the ending network site is reached. That is, operations 210-214 may be an iterative process that continues tracing through network sites and network devices, as constrained by the path parameters, until the ending network site is reached. As should be appreciated, this process may generate several potential communication paths through the one or more networks. When a generated path reaches the ending network site, the path computation tool 106 may determine, in operation 216, if the generated network path is already stored as a potential communication path. If the generated path is not stored, the path computation tool 106 may, in operation 218, store the computed communication path or otherwise provide the computed communication path to the tool for display, as explained in more detail below. If the generated path is already stored, the path computation tool 106 may, in operation 220, discard the computed communication path as already discovered. Regardless, the path computation tool 106 may proceed to operation 222 and determine if additional communication paths are to be found by the path computation tool 106. The number of generated communication paths may be based, in one implementation, on a path computation parameter provided by the computing device 122 or the user interface 124. If additional paths are to be determined, the path computation tool 106 may return to operation 210 to continue the generation of communication paths from the last discovered next-hop location. If the additional communication paths are not be discovered, the path computation tool 106 may end the process at operation 224.

In the method 200 discussed above, the path computation tool 106 generates a communication path from the starting location to the ending location. In other implementations, the path computation tool 106 may execute similar operations as described above from both the starting location and the ending location. In this implementation, the communication path is generated from both ends to meet at a location between the starting location and ending location. The path generation process may end when a common network location is found in the path being generated from the starting location and the ending location. This approach may reduce the amount of time to generate the one or more communication paths between the starting and ending locations.

Through the above process, the path computation tool 106 may determine one or more communication paths through a communications network. More particularly, the communication paths may transit multiple networks, particularly the networks 102 from which network information from network databases 104 are obtained by the path computation tool 106. Further, once the path computation tool 106 determines the one or more network communication path, communication path information may be provided to the user interface 124 for display to a user of the computing device 122. The communication path may also be provided, in some instances, to a configuration and/or orchestration tool for further processing. For example, the configuration tool may generate one or more work orders, instructions for provisioning equipment of the network, engineering processes, and the like for configuring the communication path on the network. Other systems of the network may also execute the engineering plans of the communication path to instantiate or create the path on the network.

FIG. 3 is a flowchart illustrating a method 300 for displaying a network path through a communications network in accordance with one embodiment. The operations of the method 300 of FIG. 3 may be performed by the computing device 122, the user interface 124, and/or the path computation tool 106 of the path computation system 100. The operations may be executed by hardware components of the computing device 122, software programs of the computing device, or a combination of both hardware and software components.

Beginning in operation 302, the computing device 122 may receive generated communication paths through one or more networks from the starting location to the ending location. The communication paths may be provided by the path computation tool 106 as described above. In some instances, more than one communication path may be determined and provided to the computing device 122 by the tool 106, based on a parameter provided to the tool indicating a number of requested communication paths. The received communication paths may, in operation 304, be filtered based on one or more display parameters provided via the user interface 124. For example, the computing device 122 or a user of the computing device may provide a display parameter, via the user interface 124, to display five generated communication paths through the one or more networks. In general, any number of communication paths generated by the tool 106 may be displayed or otherwise made available through the user interface 124. Other display parameters may also be provided, such as the amount of information displayed per generated path, the type of operational information associated with each generated communication path, and the like.

In operation 306, the filtered communication paths may be sorted based on one or more sorting display parameters provided via the user interface 124. For example, a user of the user interface 124 may provide a sorting parameter to sort the filtered communication paths based on a total distance of the communication path. Thus, the path computation tool 106 may calculate the distance each generated communication path travels between the starting location and the ending location and sort the filtered communication paths based on the total distance. In another example, the path computation tool 106 may calculate a transmission time to traverse the communication path. The filtered communication paths may be sorted based on this calculated transmission time for each path. In still another example, the path computation tool 106 may determine a number of optical-to-electrical-to-optical (OEO) interfaces within the calculated communications path, as OEO interfaces may increase the latency of transmission along the communication path. In general, any technical or performance aspect of the generated communication paths may be utilized as a sorting parameter to sort the filtered list of communication paths provided by the path calculation tool 106. In operation 308, the sorted list of communication paths may be provided to the user interface 124 for display on a display device of the computing device 122.

In operation 310, a selection of one of the displayed communication paths may be received via the user interface 124 or from the computing device 122. In one implementation, the selection of the communication path may be based on the sorting parameter such that the communication path with the shortest latency or the path with the shortest distance may be selected. Upon selection of the communication path, one or more of the networks 102 may be configured, altered, or provisioned based on the generated and selected communication path. The configuration of the one or more networks may be executed to provide the communication path through the networks in that one or more communication packets may be transmitted along the communication path from the starting location to the ending location. Instances in which the communication path includes an air gap or other recommendation for installation of network equipment, selection of the communication path may generate a work order for expansion of the one or more networks based on the information of the communication path. In this manner, the path computation tool 106 may direct configuration of a communications network to establish one or more communication paths through the network.

FIGS. 4-7 provide various examples of the user interface 124 for obtaining path generation and display parameters and displaying sorted communication paths generated by the path computation tool 106. In particular, FIG. 4 is an example user interface 400 for displaying a network path through a communications network based on one or more path parameters in accordance with one embodiment. The user interface 400 may be displayed on a display device associated with the computing device 122 based on information provided to the computing device by the path computation tool 106. It should be appreciated that other layouts and designs for the user interface 400 may be displayed by the computing device 122 to display aspects of the generated communication paths.

The example user interface 400 includes a map portion 402, a component visualization 406 portion, a parameter input portion 404, and a results display portion 422. The map portion 402 may include a geographical map oriented around the geographic locations of the generated communications path. That is, the map may display the geographic route a packet transmitted along the communication path may travel for transmission from the starting site to the ending site. In the example included in FIG. 4, a communication path from starting site CLLI code TEMQAZXX in Tempe, Ariz. to ending site CLLI code ELPUTXXX in El Paso, Tex. is shown. Other communication paths may be displayed in other geographic maps, depending on the geographic locations of the components included in the communication path. The map portion 402 may be interactive such that a user of the user interface 400 may zoom into or out of the displayed map using an input device, such as a keyboard or map. As the map is zoomed, additional details of the communication path may be illustrated. In particular, each network device, transmission line, junction, port, or any other component of the communication path may be associated with a geographic location. In one example, the geographic location may be a latitude value and a longitude value that locates the component at a point on the Earth. Zooming into the map portion 402 of the user interface 400 may cause additional locations of components of the communications path to be displayed. Further, each distinct location of a component along the communication path and illustrated in the map portion 402 may provide access to additional technical information associated with the communication path. For example, FIG. 5 is an example user interface 500 illustrating portions of a network path through a communications network in accordance with one embodiment. More particularly, the user interface 500 illustrates a zoomed map portion 502 of the user interface 500 centered on a portion of a generated communication path 504. As shown, the communication path 504 includes several junctions 506 in which the path diverts from a straight path. Such junctions 506 may be located within a transmission line to avoid obstacles within the geographic area of the transmission line, such as buildings, rivers, houses, trees, etc. In general, a network device or component is present at each junction 506 to divert the transmission line in another direction. Each of these network devices of the junctions 506 may be associated with a geographic location as stored in the database 104 for the respective network 102. As the geographic location for each network device may therefore be obtained by the path computation tool 106, each location may be mapped and displayed in the map portion of the user interface 500.

In addition, each mapped geographic location may include a circle or other indicator of the location of the network device. Selection of the indicator at the location may cause the user interface to display information of the device or devices of the communication path at that location. For example, a user may select the device indicator 506 to obtain additional information of a network device at that location. The location selection may be provided to the path computation tool 106 and information of the network devices associated with that location may be obtained from the data source or network databases 104. Upon retrieval, the network device information may be displayed in some manner in the user interface 500.

Returning to FIG. 4, the communication path displayed in the map portion 402 may include one or more colors along the displayed path. As mentioned above, the communication path may include network devices from more than one network database 104. In one implementation of the user interface 400, each network database may be associated with a color by the user interface or path computation tool 106. As information from the network database is obtained, the designated color for that network may be stored with the retrieved information. When displaying the communication path on the map portion 402, the user interface 400 or path computation tool 106 may determine from which database the displayed information is originally retrieved and color that portion of the communication path according to the associated color. In this manner, a user of the user interface 400 may visually determine the portions of the communication path that are a part of which network being used for the path.

In addition to the map portion 402, the user interface 400 may include a visual representation 406 of one or more network devices and/or network sites included in the computed path. In one instance, the network device visualization portion 406 may include indicators of network sites, ingress and egress devices for each network site, and transmission circuits between the network sites for the connection path. In the example shown in FIG. 4, a network site box 418 is illustrated and associated with CLLI code PHNHAZXX located in Phoenix, Ariz. Thus, the displayed communication path includes a connection through the network site 418 associated with that CLLI code. In addition, the network site box 418 may include a network device 408 through which the communication path ingresses into the network site. A transmission line circuit 410 and associated information (such as a circuit identifier) may also be displayed as connected to the ingress device 408. The ingress device 408 may be illustrated as a colored box that, in some instances, may be associated with the network to which the network device is associated, as explained above. The ingress device illustration 408 may also include a network device identifier, port identifier, interface panel identifiers, and the like for connecting to the previous network site in the communication path and for connecting to an egress device 420 for transmission out of the indicated network site 418. In general, any technical information stored in the data source 120 or database 104 associated with the ingress device 408 may be displayed in the network device visualization portion 406. Similar to the ingress device 408, a corresponding icon for an egress device 420 may also be provided in the network device visualization portion 406, connected to a next network site in the communication path.

In general, a connection between the ingress device 408 and the egress device 420 for each network site 418 may be illustrated in the network device visualization portion. In some instances, however, the path computation tool 106 may determine that a connection between the devices (or between network sites) does not currently exist within the network. In such circumstances, the lack of current connection in the network between the components may be indicated in the network device visualization portion 406 by a label of an “air gap”. As such, the path computation tool 106 may identify portions of the path in which network devices may be installed, transmission lines may be installed, connections between components may be installed, etc. to complete a connection path between the starting location and the ending location. Further, as described in more detail below, the generated communication paths may be sorted or filtered based on the number of air gaps in the communication path as installation of equipment or devices to fill in the gaps in the communication path may increase the cost of use of such a path.

The user interface 400 may also include a parameter input portion 404 that provides a location for a user to provide or select one or more parameters to control the generation of the communication path or control the display of generated communication paths. For example, the parameter input portion 404 may include a starting location input 409 in which a CLLI code, a geographic location, a site name, an address, or the like may be input to the user interface 400 as a starting location for a requested communication path. Similarly, the parameter input portion 404 may include an ending location input 407 in which a CLLI code, a geographic location, a site name, an address, or the like may be input to the user interface 400 as an ending location for a requested communication path. The use of the starting location and the ending location in generation of a communication path is described above. Other parameters for controlling or tailoring the generation of the communication paths may be input via the parameter input portion 404. For example, a dropdown menu may be provided to select from various available bandwidths or device types. In particular, FIG. 6 is an example user interface 600 for inputting a bandwidth selection via the user interface for determining a network path of a communications network in accordance with one embodiment. Several of the portions of the user interface 600 of FIG. 6 is the same or similar to that of FIG. 4, including a map portion 402, a network device visualization portion 406, and a parameter input portion 404. However, in this implementation of the user interface 600, the parameter input portion 404 may include a drop-down menu 602 for selecting from multiple device types for inclusion in the connection path. In general, the menu of device types may include any device type of any of the networks 102 from which network information is obtained. Similarly, the parameter input portion 404 may include a dropdown menu 604 for selecting from multiple available bandwidths of the networks 102. In general, the menu of device types may include any device type of any of the networks 102 from which network information is obtained. As explained above, the input parameters may be used to limit the devices and/or transmission lines included in the generated communication paths by the path computation tool 106.

In still other implementations, path computation parameters and/or path display parameters may be provided through the user interface. For example, FIG. 7 illustrates an example user interface 700 for receiving one or more parameters for determining a network path of a communications network in accordance with one embodiment. The parameters provided through the user interface 700 are merely examples and more or fewer options of path computation parameters or path display parameters may be displayed through the user interface 700. In the particular example show, a maximum path box 702 is provided through which a user of the user interface 700 may indicate a number of communication paths requested from the provided starting location to the ending location. The maximum paths parameter may be used by the path computation tool 106 when determining if additional communication paths are requested in the method 200 of FIG. 2.

The user interface 700 may also include selectable buttons 704 to request a protection communication path. Selection of the protection communication path may generate communication paths that use different network devices to protect against dropped traffic during a failure of a network device. A latency only select button 706 may instruct the tool 106 to sort determined communication paths based on a latency calculation for communication paths. This selection provides for display of the fastest transmitting communication path in the user interface 400. A DWDM only selection button 708 causes the path computation tool 106 to limit the network devices included in a generated communication path to DWDM-type devices. A diversity selection button 712 may also be included, selection of which causes the path computation tool 106 to select diverse network devices for inclusion in the communication path, including different ingress and egress cards or devices within a network site. An include/exclude TID selection button 712 may toggle the path computation tool 106 to include or exclude particular devices of the network. One or more of the above mentioned parameter selections may cause a pop-up window in the user interface for additional information to be entered. For example, a pop-up window may appear in the user interface 400 upon selection of the include/exclude TID button 712 requesting an identifier of the network device to include or exclude from the generated communication paths. It should be appreciated that other parameter selection buttons for other technical considerations of the network devices may be included in the user interface 700 for selection, such as include/exclude specific network circuits and/or avoidance of network devices shared by one or more customers to the networks.

In another example, the user interface 700 may include a drop down menu 714 for selecting devices of particular networks for inclusion in the communication path. Through this selection, a user or the computing device 122 may limit the communication path to one or more of the available networks. The user interface 700 may also include a midpoint identifier area 716 for identifying locations, identified through a CLLI code or other geographical-based identifier, for inclusion in the communication path between the starting site and the ending site. A similar exclude point area 718 may be included for identifying locations, identified through a CLLI code or other geographical-based identifier, for excluded from the communication path.

Although not illustrated in the user interfaces described herein, other display parameters may be entered via the user interfaces to select the display of particular communication paths. As explained above, the parameters may be used to filter the generated communication paths based on the parameter and/or sort the filtered communication paths for display in the user interface. Returning to FIG. 4, the user interface 400 may include a path display portion 422 for displaying information of one or more communication paths. In one particular implementation, the information displayed may be associated with the communication path illustrated in the map portion 402, although information from any number of communication paths may be displayed. The information associated with the communication path may any technical information of the generated path, including an estimated latency of the communication path, a total distance of the communication path, a number of site-to-site hops in the path, a number of device types in the path, a number of air gaps in the path, a number of 0E0 interfaces in the path, and the like. Additional or less information may be displayed in the path display portion 422 of the user interface 400.

Through the tools and interfaces provided herein, one or more communication paths through one or more networks may be generated from a starting location to an ending location. Further, the generated communication paths may be displayed for comparison by a user or computing device. Upon selection, the one or more networks may be configured or provisioned to instantiate a selected communication path in the networks. In particular, the selected communication path may be provided to one or more corresponding network configuration systems to communicate with the network devices in the communication path and alter the operating state of the network devices according to the communication path information. In some instances, communication paths that require installation of equipment or devices in the network may generate a work order for installation of the equipment in the network to complete the selected communication path. In this manner, the one or more networks may be altered to provide the requested connection between the network sites.

Some implementations of the network path tool and/or interfaces discussed above may provide an auditing of diversity aspects of a network path or circuit. For example, FIG. 8 is an example user interface 800 for receiving one or more network path parameters for auditing a diversity aspect of a network path of a communications network in accordance with one embodiment. Similar to the interfaces described above, the diversity audit interface 800 may include a parameter input portion 804 for receiving one or more inputs from a user of the interface 800 and a results display portion 802 for displaying results of the diversity audit described below. The interface 800 illustrated in FIG. 8 is but one example of an interface through which diversity of network paths may be determined or audited. In general, the path computation tool 106 described herein may receive network path information and display diversity audit information through any user interface 124 utilized by the path computation tool.

In general, a diverse network path is one that does not share network resources with another network path to prevent both paths from failing upon a failure of the shared network resources. For example, a first network path may have path diversity from another network path if the paths are not configured to transmit messages on the same fiber or other type of transmission line. In another example, the paths may have equipment diversity if the same network equipment or device is not used by both paths. Many diversity options may be requested and provided for a generated network path, including but not limited to, path diversity, equipment diversity, location diversity, site entrance diversity, card diversity, and the like. In general, any aspect or component of the network may be considered to determine diversity of two or more network paths. Further, the various types of diversity within network paths may be requested by a customer to the network when requesting the generation of a new path. For example, a customer may request a network path from a starting location (in some instances, identified by a starting CLLI code) to and ending location (also sometimes identified by an ending CLLI code), as described above. This network path request may include one or more diversity parameters, such as a request for the network path to be path diverse, equipment diverse, card diverse, etc. from other network paths associated with the customer. As mentioned, a customer to the network may request such diversity to add robust redundancy paths and prevent failures in multiple paths due to the failure of a device or transmission line of the network.

For an existing network path, a diversity parameter associated with the path against other related network paths may be audited and verified through the network path computation tool 106. In particular, a user of the user interface 124 may utilize the path computation tool 106 to determine a diversity of an existing network path against the other network paths and compare the diversity to an expected diversity (perhaps based on a diversity parameter included in the request for the path). In another example, the path computation tool 106 may be used to compare hypothetical network paths for diversity between the paths. For example, the path computation tool 106 may receive path parameters for two or more network paths and generate proposed paths through the network based on the parameters, as described above. Upon generation, the path tool 106 may conduct a diversity audit on the proposed network paths and provide results of the diversity audit via the user interface 124. In this manner, a user of the path computation tool 106 may compare established network paths or proposed network paths to determine diversity between the paths.

Returning to FIG. 8, a user of the user interface 800 may provide an indication of an existing network path via one or more inputs to the interface. For example, the user interface 800 may receive a circuit or path identifier via input box 806. In another example, other parameters associated with a network path may be provided in portion 808 of the user interface, including but not limited to a customer name, a customer identifier, a starting CLLI code, and/or an ending CLLI code for the path to be analyzed. The path computation tool 106 may use the input parameters from the user interface 800 to access one or more databases of network paths and retrieve one or more network paths associated with the input parameters. Further, the stored network path information may include one or more other of the path parameters such that path information may be automatically populated into the user interface 800 upon retrieval of the network path information. For example, the customer name, customer identifier, starting CLLI code, and/or ending CLLI code of a network path may be populated in the user interface 800 based on the network path identifier provided in input box 806. Other or fewer network path information may also be retrieved and populated in the user interface based on the inputs provided to the interface 800. In still another implementation, the path parameters may be uploaded to the tool 106 via the user interface 800 through bulk import button 810. The bulk import feature of the user interface 800 may allow for the uploading of a file or list of network paths associated with a customer to the path computation tool 106 to perform the diversity audit on the paths identified in the uploaded bulk file.

FIG. 9 is an example user interface 900 for displaying one or more network paths 914, 916 and associated parameters 910, 912 for auditing a diversity aspect of the network paths in accordance with one embodiment. In one instance, the user interface 900 of FIG. 9 may be displayed in response to receiving one or more parameters associated with a network path via the user interface 800 of FIG. 8, such as a circuit identifier. As shown in FIG. 9, the user interface 900 may include the circuit identifier in input box 906, perhaps as provided to the user interface via a user or computing device. The network path information obtained from the database in response to the circuit identifier 906 may be displayed in a results display portion 902 of the user interface. More particularly, network path information 910 of the identified circuit may be displayed, including but not limited to, a customer name, associated database, customer identifier, requested bandwidth of the path, a current status (in service, on hold, decommissioned, etc.), a starting CLLI code, an ending CLLI code, and the like. More or less path information 910 may be displayed in the user interface 900 in response to obtaining the path information from the database of network information. Additional details of the network path associated with the circuit identifier 906 may be available through a link 911 to additional information or may otherwise be made available via the user interface. In addition to the path information, a visual representation of the network path 914 may be displayed in a map portion 902 of the user interface 900. The visual representation of the network path 914 may be similar to that described above and may include a zoom feature that allows a finer granularity view of portions of the network path. In general, any of the features described above may also be accessed or utilized via the user interface 900 of FIG. 9.

Information of other network paths may also be obtained and displayed by the path computation tool 106. For example, the path computation tool 106 may determine one or more network paths associated with the network path identified by the circuit identifier 906. In general, an associated network path is one that has some correlation to the identified network path. In one particular example, an associated network path is one that is associated with the same customer and shares some aspect with the identified network path. In the example shown in FIG. 9, the associated network path is associated with the same customer to the network and has a starting CLLI code that is the same as the ending CLLI code for the identified network path of the circuit identifier 906. As should be appreciated, information associated with any number of other network paths may be displayed in the user interface 900. For example, customers with a large number of network paths may have more associated network paths than a customer with a smaller total number of network paths. Regardless of the number of associated network paths determined by the path computation tool 106, such determine paths may also be displayed on the map portion 902 of the user interface 900. In the example illustrated in FIG. 9, path information 912 may be displayed and associated with visual representation 916 of the map portion 902. Additional associated network paths may be also be displayed in both the results portion 904 and the map portion 902 of the user interface 900.

To begin the diversity audit process, the path computation tool 106 may receive a selection of two or more of the displayed network paths via the user interface 900. For example, the displayed network path information 910 or the mapped network path 914 for the path identified by the circuit identifier 906 may be selected for inclusion in the diversity audit via an input device interacting with the user interface 900. Further, one or more of the associated network paths displayed in the user interface 900 may also be selected for the diversity audit. For example, the displayed network path information 912 or the mapped network path 916 for the associated network path may also be selected for inclusion in the diversity audit via an input device interacting with the user interface 900. In one implementation, a total of six network paths (if at least five network paths are identified as associated with the network path of the circuit identifier 906) may be selected for inclusion in the diversity audit. Upon selection of the network paths for comparison to the identified network path 914, the diversity audit may begin through a selection of the audit button 908 of the user interface 900.

The path computation tool 106 may execute the diversity audit for the identified network path 914 against the selected associated network paths 912. In general, the diversity audit may include comparing one or more aspects or information associated with the identified network path 914 against a corresponding aspect or information to determine if the two or more paths share a similar network resource. Examples of the types of diversity audits the path computation tool 106 may undertake are explained in more details below. Upon executing the diversity audit, the path computation tool 106 may display the results of the diversity audit via the user interface 126. In particular, FIG. 10 is an example screenshot of a user interface 1000 displaying diversity audit results for a network path according to one implementation. Although illustrated in FIG. 10 as displayed on a user interface 1000, it should be appreciated that the results may also be provided to one or more computing devices for processing. For example, the results of the diversity audit to a customer computing device or a computing device associated with the network that may, in response to the results, generate a work order to alter a configuration of the network to address a result of the diversity audit. In another example, the results may be provided to an alarm or notification system to notify a network administrator or network customer to the audit results. Regardless, the results of the diversity audit may indicate various types of diversity of the network path associated with the circuit identifier and one or more related network paths.

In the example illustrated in FIG. 10, the audit results user interface 1000 may include a network path information portion 1002 and may, in some instances, include a customer name associated with the network path (similar to that displayed in the user interface 900 of FIG. 9), a customer identifier, and an activation date of the network path, among other information associated with the network path identified by the circuit identifier. The circuit identifier 1004 may also be displayed in the user interface 1000. Results for multiple diversity audits of the identified network path to other, related network paths may be displayed in the user interface 1000, such as through a collection of colored dots 1006-1016 with each color associated with a diversity result. Other methods of displaying the results, such as through text strings, audio, and/or video displays within the user interface 1000 are also contemplated.

The path computation tool 106 may execute a cable diversity audit and display a result 1006 of the cable diversity audit. In one implementation, cable diversity between two or more network paths indicates that the paths do not share a common transmission line, such as a fiber cable. In addition, a cable diversity audit may determine if the selected network paths share a common trench, manhole access, telephone pole, or any other structure within the network to support a transmission line. Further, the cable diversity may determine if the transmission lines utilized by the network paths are within a particular distance of each other, such as 2500 feet. The minimum distance between the network paths may be a preset value, or may be configurable by an administrator of the network or a user of the path computation tool 106. To determine the distance between the network paths, the path computation tool 106 may obtain geographic location (such as a longitude and latitude value or any other geographic location information) for each component of the respective paths and determine a distance between each location and compare the distance to the minimum threshold distance value for cable diversity. When the distance between the components or transmission lines of the two or more network paths is less than the minimum threshold distance, the network paths may be designated as not cable diverse.

The results of the cable diversity analysis by the path computation tool 106 may be compared to a cable diversity parameter of the network path. As mentioned above, the request to generate the network path may include one or more diversity designations, such as a cable diversity. The results of the cable diversity audit may, therefore, be compared to the parameter and a pass or fail indication may be displayed. In one implementation, if the cable diversity audit indicates that the network path is not cable diverse from the other selected associated network paths although the request for the network path included a cable diversity parameter, the user interface 1000 indicator 1006 may indicate a failed audit, such as through a red-colored indicator. Alternatively, if the cable diversity audit indicates that the network path is cable diverse from the other selected associated network paths in accordance with the cable diversity parameter for the network path, the indicator may indicate a passed audit, such as through a green-colored indicator. Thus, the user interface 1000 provides results of the cable diversity audit for the selected network paths.

In a similar manner, the path computation tool 106 may also conduct and display results for other types of network path diversities. For example, the path computation tool 106 may conduct a path diverse audit of the identified network path to one or more related network paths. The path diversity may compare the geographic routes taken by the network paths, particularly the location at which the network path enters a building or site of the network such that a shared entry into the site may be determined as not diverse. A minimum distance value, similar to that of the cable diversity audit, may also be applied to the path diversity audit such that, although the network paths may enter a network site at different locations, diversity may fail if the entrance locations are within the minimum distance threshold. A result 1008 of the path diversity audit may also be displayed in the user interface 1000. In the example of FIG. 10, a green-colored indicator 1008 indicates that the selected network paths are path diverse, matching a requested diversity parameter for the identified network path.

Another diversity audit includes determining a diversity of locations used by the selected network paths. The network paths may be considered location diverse if they do not share a common network site or path through a network site. For example, the network may include several sites or locations in which networking devices are operated. The sites may be interconnected through transmission lines, such as fiber or other types of cables. To determine location diversity, the path computation tool 106 may determine that the selected network paths do not transit through the same location or site. The user interface 1000 may include an indicator 1010 of the results of the location diversity. In the example of FIG. 10, however, the indicator 1010 includes a blue-colored dot. A blue-colored dot may indicate that the associated diversity was not selected for the identified network path. In other words, the request for generating the network path may not have requested a location diversity from other associated network paths. However, the path computation tool 106 may still conduct the location diversity audit, regardless of if that type of diversity is requested for the identified network path.

Similarly, the path computation tool 106 may conduct a device diversity to determine if the network paths share a common network device or component and provide an indication 1012 of the results of the audit, based on if the network path has a requested device diversity parameter associated with the path. A card diversity may also be conducted to determine if the network paths share a common card within the same network component and a results indicator 1014 may be displayed. A circuit diversity audit may also be executed to determine if the selected network paths share a common circuit through the network and an indicator 1016 of the results of the circuit diversity may be displayed in the user interface 1000. More or fewer diversity audits may be conducted on the selected network paths and displayed in a user interface than discussed herein. In addition, the user interface 1000 may provide for the exporting or saving of the audit results through activation buttons 1018.

In some implementations, one or more of the displayed results 1006-1016 may be selected and additional information associated with the result may be displayed on the user interface. For example, upon selection of a failed diversity indicator 1006, the user interface may display specific information of the network portion in which the lack of diversity occurred between the selected network paths. This information may be obtained and used to alter one or more network paths or reconfigure at least a portion of the network to obtain the type of diversity in which the audit indicated a failure. For example, selection of the indicator 1006 of the failure of the cable diversity audit may provide an identifier of the transmission line that is shared between the network paths. The network may then be altered or reconfigured to route the network path onto a different transmission line such that the network paths no longer share the same transmission line. The process of diversity auditing may be iteratively repeated to generate and verify a network path that satisfies the diversity parameters associated with the new network path request.

As mentioned above, a diversity audit may be conducted on two or more proposed network paths generated by the path computational tool 106. FIG. 11 is an example screenshot of a user interface 1100 displaying diversity comparison results for two or more network paths in accordance with one embodiment. The user interface 1100 may be used by the path computation tool 106 to display or provide diversity audit, similar to above. In this instance, however, the user interface 1100 may display the diversity audit results for multiple network paths at once. For example, the user interface 1100 of FIG. 11 may include a listing of a first network path 1102 and a second network path 1104 and the corresponding diversity audit results generated from a comparison of the two network paths. The first and second network path for comparison may be generated based on a starting CLLI code and an ending CLLI code through one or more of the techniques described above. Once generated, the network paths may be audited to determine various diversities between the paths. In the particular implementation illustrated in FIG. 11, diversity audit results comparing cable diversity 1106, location diversity 1108, device diversity 1110, card diversity 1112, port diversity 1114, circuit diversity 1116, and shelf diversity 1118. More or fewer results from the diversity audits of the network paths may be provided through the user interface 1100. The results may also be exported to a file through an export button 1120 provided in the user interface. The path computation tool 106 may therefore provide a diversity audit for two or more proposed network paths.

In some implementations, the paths included in the compare results may be uploaded as a bulk file of network paths. For example, a customer to the network may include a file of existing network paths and may upload such a file to the path computation tool 106. The tool may populate the user interface with the uploaded file for one or more diversity audits to determine a diversity status of the network paths. Similarly, a bulk file of proposed network paths may be uploaded for diversity comparison and display in the comparison results user interface. In some instances of the path computation tool 106, up to twenty network paths may be uploaded and compared for diversity. In this manner, the path computation tool 106 may be utilized to audit requested or proposed diversities for generated or proposed network paths.

FIG. 12 is a second example user interface 1200 for displaying a network path through a communications network based on one or more path parameters in accordance with one embodiment. Much of the functionality of the path computation tool 106 discussed above is available through the use of the user interface 1200 of FIG. 12 but displayed in a different format. In this embodiment, the user interface 1200 may include a map portion 1202 on which network paths 1206 may be illustrated. As above, the map portion 1202 provides a user of the interface 1200 a visual indication of network paths. In one instance, the network paths 1206 displayed on the map portion 1202 may be associated with a user identifier provided to access the user interface. For example, a customer to the network may provide a customer identifier to the user interface 1200 to manage and/or view the network paths associated with the customer identifier. The path computation tool 106 may, upon receiving the customer identifier (or any other login information), access the one or more network databases and retrieve the network paths associated with the customer identifier, as described above. The path computation tool 106 may further utilize the retrieved network path information to generate the displayed network paths 1206 of the map portion 1202. The network paths 1206 may be illustrated in a variety of ways, including in various colors. In one particular example, a selected or highlighted network path may be displayed in a different color (such as yellow) than the other displayed network paths. A user of the user interface 1200 may highlight or select a particular network path to obtain additional information about the selected path through an input device to the user interface.

In another implementation, the retrieved network paths may be illustrated in text form, such as in a list of network path identifiers and associated network path information. The user interface 1200 may allow toggling between a mapped display of the network paths and one or more types of listings of retrieved network path information. For example, the user interface 1200 may include an activation button for selecting a list view 1208 of the retrieved network paths. The user interface 1200 may also include a search function 1210 through which particular network paths may be searched for and displayed or listed. In some instances, the results of the a search entry may be limited to network paths associated with a user identifier used to log into the interface to prevent viewing of network paths not associated with a user of the interface 1200.

In some implementations, the user interface 1200 may include an interaction bar 1204 that displays one or more activation buttons for interacting with a selected network path 1206. In the example shown, the interaction bar 1204 includes an “Add a Path” button and an “Audit Diversity” button. Selection of the “Add a Path” button may cause the path computation tool 106 to add a new network path in a similar manner as described above. Also, selection of the “Audit Diversity” button may cause the path computation tool 106 to begin a diversity audit as also described above. Thus, this embodiment of the user interface 1200 may be used to perform one or more of the features and/or processes described above in relation to the user interface of FIG. 4.

As mentioned, network path information may be obtained via the user interface 1200 through a selection of a displayed network path 1206 displayed in the map portion 1202. FIG. 13 is an example screenshot of a user interface 1200 displaying network path information 1302 in accordance with one embodiment. In particular, a displayed network path 1206 of a map portion 1202 of the user interface 1200 may be selected, such as through an input device to the user interface. Upon selection, network path information 1302 may be displayed in the user interface 1200. Network path information 1302 may include a network path identifier, a path type, indication of a current status of the network path, a customer name associated with the path, a customer identifier, and the like. Additional network path 1206 information may also be displayed via the user interface 1200. For example, selection of a portion of the displayed network information 1302 may provide an expanded or alternate user interface that may display additional information of the selected network path.

The user interface 1200 may also provide for filtering of the displayed or listed network paths to view less than all of the retrieved network path information. For example, FIG. 14 is an example screenshot of a filter function of a user interface 1200 for selecting network paths 1206, 1402 for display in the user interface in accordance with one embodiment. To select particular network paths for display in the user interface 1200, a drop down menu 1408 of available network paths may be displayed. Selection of network paths from the drop down menu 1408 may cause the selected paths to be displayed on the map portion 1202 of the user interface 1200. For example, selection of network path identifier 1404 may cause network path 1410 to be displayed in the map portion 1202 and selection of network path identifier 1406 may cause network path 1402 to be displayed. In this manner, the available network paths may be filtered such that less than all of the available network paths are displayed on the map portion 1202.

As mentioned above, a new network path may be generated through the user interface 1200. In particular, FIG. 15 illustrates an example screenshot of a user interface 1500 for generating a new network path for a communication network in accordance with one embodiment. The user interface 1500 of FIG. 15 may be displayed in response to selection of the “Add a Path” button in the interaction bar 1204. The user interface 1500 may include a first portion 1502 for selecting between generating a new network path or a path diverse from an existing network path. In addition, a second portion 1504 of the user interface 1500 may be used to select a starting point for the new path. The starting point may be from an existing location (e.g., a location already included in a network path associated with the user) or from a new address or location. Regardless of the selection, the second portion 1504 may include a drop down menu 1506 in which available starting locations are listed and from which a starting location may be selected. In some instances, the list of available starting locations in the drop down menu 1506 may be filtered through input of one or more search terms into the menu. In a similar manner, an ending location for the new path may also be selected through various menus and activations displayed in the user interface 1500.

Upon selection of the start location and the end location for the new path, the user interface may display additional menus for receiving parameters of the requested new path. For example, FIG. 16 is an example screenshot of a user interface 1600 for receiving one or more network path parameters 1602-1606 for a new network path of a communications network in accordance with one embodiment. The user interface 1600 may include a menu 1602, such as a drop down menu, for selection of a bandwidth for the new path, as described above. Further, the user interface 1600 may include a menu 1604 for identifying one or more locations for inclusion in the new path and a menu 1606 for identifying one or more locations of exclusion from the new path. The path computation tool 106 may process the inclusion and exclusion locations for the new path in a similar manner as described above.

FIG. 17 is an example screenshot of a second user interface 1700 displaying diversity audit results for a network path in accordance with one embodiment. As mentioned above, the user interface may be utilized to conduct a diversity audit of existing or proposed network paths and to display the results of the diversity audit. The diversity audit may be conducted by the path computation tool 106 in a similar manner as described above. Further, the user interface 1700 may display the results of the diversity audit. For example, the user interface 1700 may display the compared network paths in a map portion 1702 of the interface. Also, the interface 1700 may include a portion providing information of the network path or paths used to determine diversity and a results portion 1706 illustrating a pass, fail, or not applicable result for the various diversity audits conducted on the network paths.

The path computation tool 106 may be used for several types of network connections or paths, including Ethernet connections or services. For an Ethernet path, the path computation tool 106 may, in response to a request for generating a new Ethernet path, build a graph database of connections focusing on Ethernet Layer 2 and Layer 3 components and/or devices of the network to generate a path from a network interface device (NID) to a provider edge (PE) device of the network. In particular, FIG. 18 is a flowchart of a method 1800 for determining an Ethernet network path through a communications network in accordance with one embodiment. The operations of the method 1800 may, in some instances, be performed by the path computation tool 106 described above through one or more hardware devices, software programs, or a combination of both hardware and software components of the path computation tool. The operations may be similar to those described above for generating a network path but applied directly to Ethernet-based Layer 2 and Layer 3 network paths.

Beginning in operation 1802, the path computation tool 106 may receive a request for an Ethernet connection via the user interface. For example, a customer to a network may access one or more of the user interfaces described above and use the interface to select to add a new Ethernet path and provide parameters associated with the new Ethernet path request. In some instances, the Ethernet path request may include a starting location and an ending location for the Ethernet path. Similar to above, however, it should be appreciated that the network path may be bi-directional and the starting location and ending location may merely define endpoints for the requested Ethernet path. Other parameters of the Ethernet path may be included in the request, such as inclusions and/or exclusions of hops, bandwidth, product type, on-net or off-net connectivity, or other technical features of the Ethernet path, and the like.

In operation 1804, the path computation tool 106 may obtain or determine available Ethernet-based network devices for inclusion in the requested Ethernet path. For example, the path computation tool 106 may determine a network interface device (NID), a metro edge (ME) device, a provider edge (PE) device, or any other component of the network utilized to provide Ethernet connectivity to a customer of the network. In some instances, the path computation tool 106 may determine which available Ethernet-based network devices are closest, either geographically or logically, to the starting location and/or the ending location for the requested Ethernet path. The path computation tool 106 may also determine one or more configurations of the determined network components, particularly the components at the starting location. The determined configurations may indicate a type of available Ethernet products at the starting location and may aid in configuring the components along the determined Ethernet path to support the available Ethernet products for the path.

Upon determining available Ethernet-based network devices and configurations, the path computation tool 106 may calculate or otherwise determine the devices utilized for the requested Ethernet path from the starting location to the ending location in operation 1806. In one particular instance, the path computation tool 106 may determine the path from the metro edge to the provider edge within the network. In general, the determined path provides Ethernet connectivity to the customer as the closest provider edge device that supports the determined Ethernet product for the requested path. In addition, the determine Ethernet path may be on-net or off-net, as included in the received request.

In operation 1808, the path computation tool 106 may provide one or more parameters of the determined Ethernet network path to the user interface for display via the interface, similar to the network path displays discussed above. The user interface may, upon receipt of the parameters of the determined Ethernet network path, display aspects of the path, such as a representation of the path in a map portion of the user interface and/or a display of path information associated with the Ethernet path, such as network device identification, a customer identifier associated with the Ethernet path, a bandwidth of the path, starting and ending locations, and the like. Further, the path computation tool 106 may provide the Ethernet path parameters to a provisioning system of the network for configuration of the Ethernet path onto the network to provide the requested Ethernet service to the requesting customer. In this manner, the path computation tool 106 may be utilized for generation of Ethernet-based network paths, in addition to other types of network paths.

FIG. 19 is a block diagram illustrating an example of a computing device or computer system 1900 which may be used in implementing the embodiments of the components of the network disclosed above. For example, the computing system 1900 of FIG. 19 may be the computing device 122 discussed above. The computer system (system) includes one or more processors 1902-1906. Processors 1902-1906 may include one or more internal levels of cache (not shown) and a bus controller or bus interface unit to direct interaction with the processor bus 1912. Processor bus 1912, also known as the host bus or the front side bus, may be used to couple the processors 1902-1906 with the system interface 1914. System interface 1914 may be connected to the processor bus 1912 to interface other components of the system 1900 with the processor bus 1912. For example, system interface 1914 may include a memory controller 1918 for interfacing a main memory 1916 with the processor bus 1912. The main memory 1916 typically includes one or more memory cards and a control circuit (not shown). System interface 1914 may also include an input/output (I/O) interface 1920 to interface one or more I/O bridges or I/O devices with the processor bus 1912. One or more I/O controllers and/or I/O devices may be connected with the I/O bus 1926, such as I/O controller 1928 and I/O device 1930, as illustrated.

I/O device 1930 may also include an input device (not shown), such as an alphanumeric input device, including alphanumeric and other keys for communicating information and/or command selections to the processors 1902-1906. Another type of user input device includes cursor control, such as a mouse, a trackball, or cursor direction keys for communicating direction information and command selections to the processors 1902-1906 and for controlling cursor movement on the display device.

System 1900 may include a dynamic storage device, referred to as main memory 1916, or a random access memory (RAM) or other computer-readable devices coupled to the processor bus 1912 for storing information and instructions to be executed by the processors 1902-1906. Main memory 1916 also may be used for storing temporary variables or other intermediate information during execution of instructions by the processors 1902-1906. System 1900 may include a read only memory (ROM) and/or other static storage device coupled to the processor bus 1912 for storing static information and instructions for the processors 1902-1906. The system set forth in FIG. 19 is but one possible example of a computer system that may employ or be configured in accordance with aspects of the present disclosure.

According to one embodiment, the above techniques may be performed by computer system 1900 in response to processor 1904 executing one or more sequences of one or more instructions contained in main memory 1916. These instructions may be read into main memory 1916 from another machine-readable medium, such as a storage device. Execution of the sequences of instructions contained in main memory 1916 may cause processors 1902-1906 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available through a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 1906 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 1916, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

We claim:

1. A method for managing a communications network, the method comprising:
receiving, at a processing device via a user interface, an identification of a first geographic location and an identification of a second geographic location, both associated with a network;
generating, based on a path parameter and obtained network information, a communication path from a first network device located at the first geographic location to a second network device located at the second geographic location, the communication path comprising a third network device physically connected between the first network device and the second network device and a network circuit connecting the first network device to the third network device; and
generating a display of a visual representation of the communication path, the visual representation comprising an interactive map comprising an identification of the first network device, an identification of the third network device, an identification of the network circuit, and a geographic representation of the communication path in the interactive map.

2. The method of claim 1 further comprising:
obtaining first configuration information from a first network and second configuration information from a second network different than the first network, the first configuration information in a first format and the second configuration information in a second format different than the first format.

3. The method of claim 2 further comprising:
translating the first configuration information and the second configuration information into a common format.

4. The method of claim 1, wherein generating the communication path comprises:
obtaining, based on the network information, a first network device information associated with a first network device of the first geographic location;
obtaining a second network device information associated with a second network device of the second geographic location; and
identifying a first transmission line for transmitting communications between the first network device and the third network device and a second transmission line for transmitting communications between the second network device and the third network device.

5. The method of claim 1, further comprising:
obtaining a plurality of network paths from the first network device to the second network device; and
selecting the communication path comprising the third network device based on path parameter.

6. The method of claim 1, wherein the path parameter comprises one of an indication of a network device type, an indication of a bandwidth, an indication of a transmission type, an identifier of a network site for inclusion in the communication path, or an identifier of a network site for exclusion in the communication path.

7. The method of claim 1, wherein display of the visual representation is based on an estimated distance of the communication path.

8. The method of claim 1, wherein display of the visual representation is based on an estimated latency of a transmission on the communication path.

9. The method of claim 1 further comprising:
receiving, via a user interface, an identification of the first network device located at the first geographic location and an identification of the second network device located at the second geographic location.

10. The method of claim 1 further comprising:
configuring the network based on the generated communication path.

11. A system for managing a communications network, the system comprising:
one or more processors; and
a non-transitory storage device including computer executable instructions that, when executed by the one or more processors, cause the one or more processors to:
obtain, based on an identification of a first network path of a communication network, an identification of a second network path associated with the first network path;
determine a diversity of components of the first network path to associated components of the second network path; and
generate a displayable result of a comparison of the determined diversity of the components of the first network path to associated components of the second network path, the comparison based on a diversity parameter of a request associated with the first network path.

12. The system of claim 11 wherein the computer executable instructions, when executed by the one or more processors, further cause the one or more processors to:
obtain an identifier of one or more transmission lines of the first network path; and
when the second network path comprises the identifier of the one or more transmission lines, generate a failed cable diversity result of the comparison of the determined diversity of the components of the first network path to associated components of the second network path.

13. The system of claim 11 wherein the computer executable instructions, when executed by the one or more processors, further cause the one or more processors to:
obtain an identifier of an ingress location to a physical building site of the communication network associated with the first network path; and
when the second network path comprises the identifier of the ingress location to the physical building site, generate a failed path diversity result of the comparison of the determined diversity of the components of the first network path to associated components of the second network path.

14. The system of claim 11 wherein the computer executable instructions, when executed by the one or more processors, further cause the one or more processors to:
obtain an identifier of a network device of the communication network associated with the first network path; and
when the second network path comprises the identifier of the network, generate a failed device diversity result of the comparison of the determined diversity of the components of the first network path to associated components of the second network path.

15. The system of claim 14 wherein the computer executable instructions, when executed by the one or more processors, further cause the one or more processors to:
obtain an identifier of a port of the network device of the communication network associated with the first network path; and
when the second network path comprises the identifier of the port of the network device, generate a failed port diversity result of the comparison of the determined diversity of the components of the first network path to associated components of the second network path.

16. The system of claim 11 wherein the computer executable instructions, when executed by the one or more processors, further cause the one or more processors to:
receive, via a user interface, an input comprising the identification of the second network path associated with the first network path.

17. The system of claim 11 wherein the parameter of the request associated with the first network path comprises a requested diversity between the first network path and the second network path.

18. The system of claim 11 wherein the computer executable instructions, when executed by the one or more processors, further cause the one or more processors to:
configure the network based on the comparison of the determined diversity of the components of the first network path to the associated components of the second network path.

19. The system of claim 18, wherein configuring the network comprises generating a third network path on the communication network, the third network path satisfying the diversity parameter of the request associated with the first network path.

20. The system of claim 11 wherein the association of the first network path and the second network path comprises a shared endpoint identifier.
